(19) United States
(12) Patent Application Publication
(10) Pub. No.: US 2024/0144608 A1
(43) Pub. Date: May 2, 2024

(54) CONTEXT-SENSITIVE OVERLAY OF CONTENT VIA AUGMENTED REALITY DEVICE

(71) Applicant: Mercedes-Benz Group AG, Stuttgart (DE)

(72) Inventor: Sorin Panainte, Holland, MI (US)

(21) Appl. No.: 17/979,633

(22) Filed: Nov. 2, 2022

(51) Int. Cl. G06T 19/00; G01C 21/36

(52) U.S. Cl. CPC G06T 19/006; G01C 21/3638

(57) ABSTRACT

Briefly, example methods, apparatuses, and/or articles of manufacture may be implemented to convey content to or via an augmented reality device. In an embodiment, a method may estimate the location of the augmented reality device with respect to one or more known areas of a grid. The method may continue with determining the orientation of a field-of-view of the augmented reality device and transmitting context-sensitive content relevant to or associated with one or more real objects viewable within the field-of-view of the augmented reality device based, at least in part, on the one or more known areas of the grid.

### BACKGROUND

### 1. Field

The present disclosure relates generally to augmented reality devices, as such devices may be utilized to present context-sensitive content to an individual.

### 2. Information

The World Wide Web or simply the Web, as enabled by Internet computing, switching, and wireless and wireline transmission resources has grown rapidly in recent years. Such developments have facilitated a wide variety of different transaction types to occur utilizing the wireless Internet infrastructure. This allows individuals to remain connected or coupled to the Internet while driving a vehicle (e.g., an automobile or motorcycle), walking, biking, or engaged in a variety of other activities. Such connectivity is facilitated by the recent buildout of wireless Internet infrastructure that allows individuals to shop, perform electronic banking, stay connected with friends, family, work colleagues, business associates, etc., while on-the-go in a highly mobile society. This allows individuals to go about their daily routines of working, attending school, shopping, driving, and so forth, without being out of touch for significant periods of time.

In some instances, such as while an individual is seated in a vehicle, walking, or biking in an unfamiliar environment, the individual may benefit from visual cueing to assist in obtaining, for example, automobile services (e.g., fuel, electric charging), obtaining food and beverage, etc. Thus, an individual may utilize a communications device, such as a mobile cellular communications device, which may inform the individual whether desired goods and/or services may be obtained. In particular examples, certain types of augmented reality devices may render an overlay of symbols, which the individual may view in addition to imagery comprising real objects within an area of interest. Accordingly, it may be appreciated that providing individuals with useful information that is relevant to an individual's interests and needs continues to be an active area of investigation.

### SUMMARY

One general aspect includes an augmented reality controller for conveying content to an augmented reality device in communication with a vehicle. The augmented reality controller has one or more processors communicatively coupled to at least one memory device including computer code. The at least one memory device and the computer code are configured to cause with the one or more processors to estimate a location of the augmented reality device with respect to one or more known areas of a grid. The one or more processors of the augmented reality controller are also configured to determine the orientation of a field-of-view of the augmented reality device, and to transmit context-sensitive content to the augmented reality device via the vehicle, the context-sensitive content being relevant or otherwise associated with one or more real objects viewable within the field-of-view of the augmented reality device, wherein the content is generated based, at least in part, on the one or more known areas of the grid.

In particular embodiments, the augmented reality controller with the one or more processors coupled to the at least one memory device is additionally to access a cloud-based data storage device to determine the relevant context-sensitive content based, at least in part, on one or more content preferences of an individual that is currently in the vehicle or who satisfies a predefined proximity condition relative to the vehicle. In particular embodiments, the augmented reality controller with the one or more processors coupled to the at least one memory device is additionally to perform direction of access of content from the data store based, at least in part, on a user selection of a type-of-travel context from among a plurality of selectable type-of-travel contexts. In particular embodiments, the augmented reality controller with the one or more processors, in response to selection of a type-of-travel, the one or more processors coupled to the at least one memory device, is additionally to perform transmission to the augmented reality device, via the vehicle, of the context-sensitive content relevant to the one or more real objects based, at least in part, on the one or more real objects being located along a driving path of travel of the vehicle. In particular embodiments, the augmented reality controller with the one or more processors, responsive to selection of a type of travel, is additionally to perform a transmission to the augmented reality device, via the vehicle, of the context-sensitive content associated with the one or more real objects based, at least in part, on the one or more real objects being located along a walking path of travel. In particular embodiments, the augmented reality controller with the one or more processors coupled to the at least one memory device is additionally to perform reception of a selection of at least one of the one or more known areas of the grid from among a plurality of uniformly-sized areas proximate to the estimated location of the vehicle. In particular embodiments, the plurality of uniformly-sized areas corresponds to areas of approximately 3.0 m by approximately 3.0 m. In particular embodiments, the augmented reality controller with the one or more processors coupled to the at least one memory device is additionally to perform a determination of whether the one or more real objects viewable within the field-of-view of the augmented reality device is relatively nearby or is relatively distant from an individual co-located with the augmented reality device. In particular embodiments, the augmented reality controller with the one or more processors coupled to the at least one memory device is additionally to perform a determination of whether the one or more real objects viewable within the field-of-view of the augmented reality device is located within a peripheral portion of or within a central portion of a field of view of an individual co-located with the augmented reality device. The central portion may correspond with a direct line of sight of the individual. In particular embodiments, the augmented reality controller with the one or more processors coupled to the at least one memory device is additionally to receive, from user interface of the vehicle, of a selection to display the context-sensitive content utilizing alphanumeric characters, graphical icons, or a combination thereof.

Another general aspect includes a method to provide content to an augmented reality device in communication with a vehicle, including resolving a location of the augmented reality device with respect to one or more known areas of a grid. The method also includes determining the orientation of a field-of-view of the augmented reality device. The method also includes generating and/or transmitting, via the vehicle, context-sensitive content associated with one or more real objects viewable within the field-of-view of the augmented reality device based, at least in part, on the one or more known areas of the grid.

In particular embodiments, the method may further include directing access to a data store to determine the associated with context-sensitive content based, at least in part, on one or more content preferences of an individual co-located with, or proximate to, the vehicle. In particular embodiments, the method may further include selecting a type-of-travel context of an individual from among a plurality of types-of-travel contexts. In particular embodiments, the method may further include transmitting, responsive to selecting a type of travel, the context-sensitive content associated with the one or more real objects based, at least in part, on the one or more real objects being located along a driving path of travel of the vehicle. In particular embodiments, the method may further include selecting the one or more known areas of the grid from among a plurality of uniformly-sized areas proximate to the location of the augmented reality device and/or the vehicle. In particular embodiments, the uniformly-sized areas correspond to areas approximately 3.0 m by approximately 3.0 m.

Another general aspect includes a non-transitory computer-readable medium including program instructions for causing an augmented reality device controller to perform an estimation of a location of the augmented reality device with respect to one or more known areas of a grid. The non-transitory computer-readable medium may also cause an augmented reality device controller to perform a determination of the orientation of a field-of-view of the augmented reality device. The non-transitory computer-readable medium may also cause an augmented reality device controller to transmit context-sensitive content to the augmented reality device via a vehicle, the context-sensitive content being associated with one or more real objects viewable within the field-of-view of the augmented reality device based, at least in part, on the one or more known areas of the grid.

In particular embodiments the non-transitory computer-readable medium may also cause an augmented reality device controller to direct access to a cloud-based data store to determine the associated context-sensitive content based, at least in part, on one or more content preferences of an individual co-located with the augmented reality device and/or the vehicle. In particular embodiments, the non-transitory computer-readable medium may also cause an augmented reality device controller perform a selection of a type-of-travel context of an individual from among a plurality of types-of-travel contexts. In particular embodiments, the non-transitory computer-readable medium may also cause an augmented reality device controller to perform a determination of whether the one or more real objects viewable within the field-of-view is relatively nearby or is relatively distant from an individual co-located with the augmented reality device. In particular embodiments, the non-transitory computer-readable medium may also cause an augmented reality device controller perform a determination of whether the one or more real objects viewable within the field-of-view of the augmented reality device is located within a periphery of or within a direct line-of-sight of an individual co-located with the augmented reality device.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, may best be understood by reference to the following detailed description if read with the accompanying drawings in which:

FIG. 1 is a diagram of a vehicle having wireless connectivity with a communications infrastructure and coupled to augmented reality glasses, according to an embodiment.

FIG. 2 is a diagram of a vehicle in wireless communication with augmented reality glasses to display associated content generated by a content generator, according to an embodiment.

FIG. 3 depicts a view from a passenger located in a vehicle and viewing real objects while traveling on a road, according to one or more embodiments.

FIG. 4 depicts an individual walking in a city environment while wearing augmented reality glasses, according to an embodiment.

FIG. 5 depicts a dashboard of a vehicle, showing a display to configure augmented reality glasses, according to an embodiment.

FIG. 6 is a diagram showing the content generator of FIG. 2 along with a portion of a city that has been divided into uniformly-sized areas of a grid, according to an embodiment.

FIG. 7 is a diagram showing real objects viewable through augmented reality glasses wherein certain real objects are nearby to, and other real objects are relatively distant from, the augmented reality glasses, according to an embodiment.

FIG. 8 is a diagram showing certain angles in the line of sight and periphery areas viewable by augmented reality glasses, according to an embodiment.

FIG. 9 is a first flowchart for a method for context-sensitive overlay of content via an augmented reality device, according to an embodiment.

FIG. 10 is a second flowchart for a method for context-sensitive overlay of content via an augmented reality device, according to an embodiment.

FIG. 11 is a diagram of a communications infrastructure that includes both wireless and wireline communications devices and components, according to various embodiments.

FIG. 12 is a diagram showing a computing environment, according to an embodiment.

Reference is made in the following detailed description to the accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

Throughout this specification, references to one implementation, an implementation, one embodiment, an embodiment, and/or the like, means that a particular feature, structure, characteristic, and/or the like described in relation to a particular implementation and/or embodiment is included in at least one implementation and/or embodiment of claimed subject matter. Thus, appearances of such phrases are not necessarily intended to refer to the same implementation or embodiment or to any one particular implementation or embodiment. Furthermore, it is to be understood that particular features, structures, characteristics, or the like described, are capable of being combined in various ways in one or more implementations and/or embodiments and, therefore, are within intended claim scope. In general, for the specification of a patent application, these and other issues have a potential to vary in a particular circumstance of usage. In other words, throughout the disclosure, particular circumstances of description and/or usage provides guidance regarding reasonable inferences to be drawn. The phrase “as the term is used herein” in general without further qualification refers at least to the setting of the present patent application.

As previously alluded to, the World Wide Web, as enabled by Internet computing, switching, and wireless and wireline transmission resources, has grown rapidly in recent years. Such developments have facilitated a wide range of electronic communications to occur utilizing the wireless Internet infrastructure. Thus, in many instances, an individual may remain connected or coupled to the Internet while driving a vehicle (e.g., a car or a motorcycle), walking, running, biking, or while engaged in a variety of other activities. Such connectivity is facilitated by the recent buildout of wireless Internet infrastructure that allows individuals to shop, perform electronic banking, play games, stay connected with friends, family, work colleagues, business associates, etc., all of which while on-the-go in a highly mobile society. This allows individuals to go about their daily routines of working, attending school, shopping, driving, and so forth, while remaining in touch with friends, family, colleagues, etc.

An important component that facilitates the continuous connectivity of individuals with the worldwide wireless communications infrastructure has been the mobile cellular telephone. As capabilities of mobile cellular devices continue to increase, such devices have become increasingly useful as intermediaries between, for example, wearable devices and an overarching wireless communications infrastructure. For example, a smartwatch, a biometric sensor, a physiological sensor, etc., may operate in association with an individual subscriber's mobile communications device. In recent years, in addition to the above-identified devices, augmented reality devices, such as augmented reality glasses or other wearable augmented reality devices, have become increasingly prevalent as an approach toward presenting visual cues to individuals, thereby permitting such individuals to gather information more quickly with respect to their surroundings, receive visual warnings of potentially hazardous events, and/or become more time-efficient in finding needed goods and/or services.

In one example, such as while an individual (e.g., driver, passenger) is seated in a vehicle, walking, or biking in an unfamiliar environment, the individual may benefit from visual cueing to assist in obtaining certain services. Such services may include obtaining automobile fuel, locating a facility for electrified automobile charging, obtaining food and beverages, obtaining directions to a residence or establishment, or the like. In particular instances, certain augmented reality wearable devices, such as augmented reality glasses, may render an overlay of virtual features (e.g., symbols), which the individual may view in addition to real objects within the field of view of the augmented reality glasses.

However, certain wearable devices, such as particular types of augmented reality glasses, may introduce unacceptable latencies in presenting associated virtual features (e.g., symbols and/or other parameters) to an individual wearing the wearable device. For example, some augmented reality device technologies utilize an imaging device (e.g., camera), which may operate by capturing an image and conveying certain image parameters over a wireless communications link to a centralized image processing system. In an example, an imaging device may extract one or more keypoints from a captured image, which may involve a computer vision technique (e.g., image recognition). Parameters of the keypoint may be compared with images stored in a database until a match between a captured image and a stored image has been determined. In response to such matching, an image processing computer may insert appropriate visual content or other content, which may be overlaid or otherwise positioned at a location that is determined or estimated with respect to the one or more extracted key points. Thus, it may be appreciated that such processes, which involve image capture, keypoint extraction, transmission of appropriate parameters through wireless infrastructure for comparison with images from a centralized database, followed by detection of a match utilizing stored and captured image keypoints, followed by content insertion and transmission through a wireless infrastructure, may consume several seconds or longer. Such delays reduce the appeal of wearable augmented reality devices, such as augmented reality glasses.

However, in particular nonlimiting embodiments as described herein, relevant or associated content may be transmitted and displayed via wearable augmented reality devices (e.g., augmented reality glasses) without introducing undesirable delays in presenting relevant or associated content to an individual. For example, in particular embodiments, a mobile communications device (e.g., mobile phone), which may be held or carried by an individual wearing augmented reality glasses, may estimate, resolve, or otherwise determine a location of the mobile communications device using geolocation techniques, such as those described hereinbelow. The mobile communications device may transmit, to one or more processors of another computing device/system, location information that describes the determined, estimated, or resolved location. The location information may comprise a small set of identifiers, such as location coordinates describing, for example, longitude, latitude, and elevation, and may be transmitted through a wireless communications infrastructure. Responsive to receipt of estimated location coordinates, the one or more computer processors may access a data store (also referred to as a data storage device), which may provide appropriate visual content (also referred to as displayable content), such as symbols and/or alphanumeric text, for example, which is relevant to or otherwise associated with the determined, estimated, or resolved location. This visual content may then be transmitted through the wireless communications infrastructure, and may be overlaid on an individual's augmented reality glasses or other wearable device. Thus, an overlay of visual content for an AR application may occur with much less latency than competing approaches, such as those that involve extraction of keypoints of a captured image, comparison of keypoints from the captured image with a database of key points, either of which may introduce significant latency in generating content associated with an image viewed via augmented reality glasses.

In such context, the term “augmented reality device” may include any device that permits viewing of a real scene (also referred to as a physical scene) that includes one or more real objects (also referred to as one or more physical objects) through one or more screens (e.g., transparent lenses of AR glasses), and also permits viewing of artificial objects (also referred to as virtual objects), which may be overlaid over the real scene on the screen (e.g., overlaid on the one or more transparent lenses). Accordingly, an augmented reality (AR) device may comprise glasses, for example, which permit viewing of real objects in a scene augmented with artificial (e.g., computer-generated) content. Thus, in an example, a passenger or an operator (e.g., driver) of a transportation vehicle may use an AR device to view real objects in the vehicle's environment, such as other vehicles, traffic signs, lane markings, etc., along with computer-generated visual features (e.g., symbols, text, or the like). In this example, the visual content presented by the AR device may identify, for example, the real objects in the vehicle's environment, along with computer-generated text and/or icons that may provide context and/or metadata that describes or otherwise relates to the real objects. The AR device in this example may be AR glasses. In another example, an augmented reality (AR) device may include a projector to display imagery on a vehicle windshield, in which such imagery identifies real objects viewable through the windshield or provides context and/or metadata respective of the real objects.

In some embodiments, an augmented reality device being used by an individual may determine descriptors or other information that indicate the individual's location, such as by computing the location using GPS or other satellite positioning signals. In particular embodiments, in addition to determining such location information, the augmented reality device (e.g., augmented reality glasses) may determine and transmit information indicating an orientation or heading of a field-of-view of the individual using the augmented reality device. More particularly, this may be a field-of-view visible through the lens or lenses of the augmented reality device or visible through a vehicle windshield. Thus, responsive to an individual wearing augmented reality glasses, for example, and the individual being located within a particular known area of a grid, the augmented reality device or another computing device may obtain or determine a known area of a grid at which the individual is looking based on an angle of orientation of a field-of-view visible via the augmented reality glasses, for example. Accordingly, in one possible example, in response to determining that an individual wearing augmented reality glasses, for example, is looking northward while at a particular corner of a downtown area, one or more computer processors communicatively coupled to a database may generate and transmit content that is relevant to or otherwise associated with one or more known areas of a grid located immediately north of the individual. In addition, the one or more computer processors may determine content based on the individual's gaze, or more particularly based on an area at which an individual's gaze is directed. For instance, the augmented reality device may determine that the individual's gaze is focused on a nearby area. In such an example, the one or more computer processors may provide content that is exclusively relevant to or associated with the nearby area based, at least in part, on the determination from the augmented reality glasses. Alternatively, in response to the augmented reality glasses determining that an individual's gaze is focused on an area that is relatively distant from the individual, the one or more computer processors may provide content that is relevant to or associated with the one or more distant areas.

In particular embodiments, one or more computer processors coupled to a database may convey or transmit content that accords with a context that is selected for an individual wearing or otherwise using an augmented reality device, such as augmented reality glasses. As the term is used herein, “context” refers to a setting, environment, and/or circumstances of the usage of an augmented reality device, such as augmented reality glasses or other wearable augmented reality device. Accordingly, in particular embodiments such as those involving a driver or passenger of a vehicle, augmented reality glasses, for example, may be utilized in a vehicle “driver” context, in which (for example, exclusively) safety-related content (e.g., characters and/or symbols and/or icons) are overlaid on real objects viewable through the glasses. Likewise, in particular embodiments as previously indicated, augmented reality glasses may be utilized in a vehicle “passenger” context, which may bring about display of other alphanumeric messages, symbols, indicators, or the like, which may possess more informational content, which may accord with a passenger's preferred content. In particular embodiments, a user interface, such as a menu displayed on a dashboard of a vehicle, may present different types of content, such as content related to charging stations, food and beverage establishments, shopping, etc., that can be selected by a driver, passenger, or other individual, and the content which is presented on the augmented reality device may be based on the selection. Further, a mode of display via the augmented reality glasses, such as text descriptions and/or illustrative, graphical icons, may also be selectable via the user interface. In addition, also in particular embodiments, additional content may be presented to a user, such as in response to a user subscribing to enhanced augmented reality content. In an example, in response to a user approaching a food and beverage establishment, augmented reality glasses may display a menu of the establishment, based, at least in part, on the user's paid-up subscription to such additional content. In another example, when approaching a museum, augmented reality glasses may display discount codes, a brief description of current displays at the museum, opening/closing hours, and/or admission fees, just to name a few non-limiting examples.

Further, in particular embodiments, the augmented reality device may detect a current context of an individual as being a “walking” context. This walking context may arise, e.g., responsive to a driver or passenger exiting a vehicle and walking about, perhaps while the augmented reality device is within communication range of the vehicle. The augmented reality device may be a wearable device, such as the augmented reality glasses described above. In a walking context, for example, the wearable device of an individual may display a number of messages, symbols, indicators, or the like, which may be appropriate, or identified as being preferred, by the individual walking along a street in a shopping district, an entertainment district, a restaurant district, or any other type of environment, and claimed subject matter is not limited in this respect.

As the term is used herein, “context-sensitive content,” or similar terms, refers to content that is provided to an individual (e.g., an individual driving a vehicle, a passenger within a vehicle, an individual walking within communication range or other a distance of a vehicle, or the like), in accordance with a selectable setting or environment of the individual. Thus, for example, one or more computer processors of an individual's augmented reality device, the individual's vehicle, and/or in a server in communication with the augmented reality device or the vehicle may detect a context in which the individual using the augmented reality device is the vehicle's driver while, e.g., the vehicle is traveling on a highway. Responsive to such a determination, the one or more computer processors (which may be communicatively coupled to a database) may determine that in such a context, little or no content should be provided to the individual via the augmented reality device, so as not to distract from the individual's driving. In such instances, certain indicators may be provided so as to indicate that a vehicle is relatively low on fuel or, for example, low on electric charge. In another example, the one or more processors may detect a context in which the individual using the augmented reality device is a passenger in a vehicle. In that context, the one or more computer processors (e.g., coupled to a database) may determine that context-sensitive content for the individual relates to real objects such as landmarks, buildings, restaurants, fueling/charging stations, and/or other non-safety related messages and/or symbology. In another example, while operating in a road-travel context, augmented reality glasses may provide context-sensitive content that provides notifications of upcoming potential emergency situations, notifications relevant to or associated with road conditions, notifications to indicate upcoming congestion, construction zones, detours, etc.

In addition to providing context-sensitive content relevant to or associated with real objects viewable from a vehicle driving along a path of travel, a wearable augmented reality device, such as augmented reality glasses, may provide content that relates to a walking path of travel. In one possible scenario, as an individual walks among establishments of a popular shopping district, augmented reality glasses may indicate those stores and/or establishments which offer discounts, sales, and/or other promotions. Further, in an example, an individual may select content preferences in accordance with the individual's shopping preferences (e.g., women's apparel, men's apparel, sporting goods, kitchen utensils, etc.). Based, at least in part, on such selected content preference(s), as an individual walks within various locations of the shopping district, an augmented reality device (e.g., augmented reality glasses) may display content that accords with the selected content preferences.

It should be noted that the augmented reality device or another computing device may use signals from a satellite positioning system to estimate, resolve, or otherwise determine an individual's mobile communications device responsive to the individual walking among stores in an outdoor mall area, for example. However, responsive to an individual walking among stores in an indoor mall area, a mobile communications device may utilize other approaches to determine, estimate, and/or resolve a position of the individual's mobile communications device.

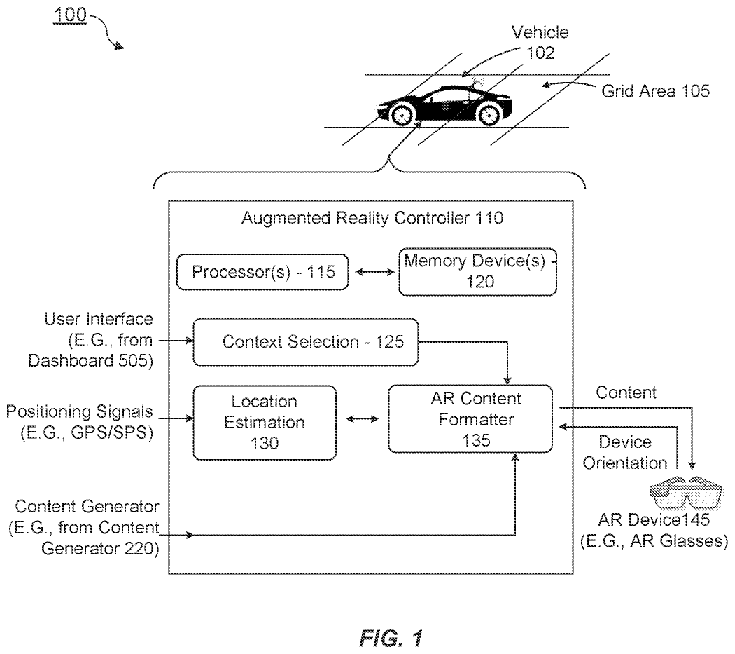

In view of the description of a general, overarching communications infrastructure as shown and described in reference to FIG. 1, more particular embodiments directed toward context-sensitive overlay of content via an augmented reality device are discussed hereinbelow. In FIG. 1, for example, vehicle 102, which may represent an electrified vehicle, for example, may be equipped with augmented reality controller 110, which may operate to format, generate, and/or transmit augmented reality content to an augmented reality device 145 of an operator (e.g., a driver) or a passenger of vehicle 102. Thus, in particular embodiments, as vehicle 102 travels along a path of travel, an operator of vehicle 102 (and/or a passenger of vehicle 102), may view augmented reality content displayed, for example, by an augmented reality device 145. As shown in FIG. 1, a path of travel of vehicle 102 may be divided into substantially equal-sized areas of a grid (also referred to as grid areas). For example, as shown in FIG. 1, vehicle 102 may traverse a path that, at least momentarily, occupies grid area 105. A moment later, vehicle 102 may occupy an adjacent area of the grid, for example. While vehicle 102 traverses areas of a grid, a computing device on the vehicle or another computing device may determine and report a position of vehicle 102, which may bring about display of content that is relevant to or associated with the areas of the grid. In one possible example, as vehicle 102 traverses an area proximate to a restaurant, an augmented reality device (e.g., augmented reality glasses 145) may display content that is relevant to or associated with the restaurant in response to an operator or passenger of vehicle 102 gazing in the direction of the restaurant. Such displayed content may relate to a menu of the restaurant, hours of operation, specials, and so forth.

Viewing of augmented reality content by a passenger and/or an operator (e.g., a driver) of vehicle 102 may be facilitated by onboard augmented reality controller 110, shown in FIG. 1. In particular embodiments, the augmented reality controller 110 may be a computing device (e.g., infotainment system controller and/or telematics control unit (TCU)) that forms or is part of a head unit that provides a human machine interface (HMI), and may include a processor(s) 115 and a memory device(s) 120 (which may also be referred to as non-transitory computer-readable medium/media). The memory device(s) 120 may include instructions that are executable by the processor(s) 115, including instructions for a context selection module 125, a location estimation module 130, and an AR content formatter module 135, which are discussed in more detail below. In these embodiments, content viewable by a passenger and/or an operator of vehicle 102 may be controlled by processor 115 (e.g., comprising one or more computer processors), which may be coupled to memory device(s) 120, which may control functions associated with augmented reality controller 110. In particular embodiments, augmented reality controller 110 may comprise an input port, which receives signals from a user interface (also referred to as a HMI), also referred to as a user interface signal. In an embodiment, user interface signals received by controller 110 may relate to selectable content preferences expressed by a passenger and/or a driver of vehicle 102. For example, in an embodiment, an operator or passenger of vehicle 102 may prefer to view exclusively safety-related content (e.g., safety-related text and/or icons or symbols), which may be relevant to or associated with grid area 105, or other grid areas traversed by vehicle 102. In another example, an operator or passenger of vehicle 102 may prefer to view parameters related to upcoming points of interest, as vehicle 102 travels among grid areas, such as those shown in FIG. 1. Additional implementation details with respect to a passenger's or an operator's selection of various contexts selectable via context selection module 125, are described in greater detail with respect to FIG. 5.

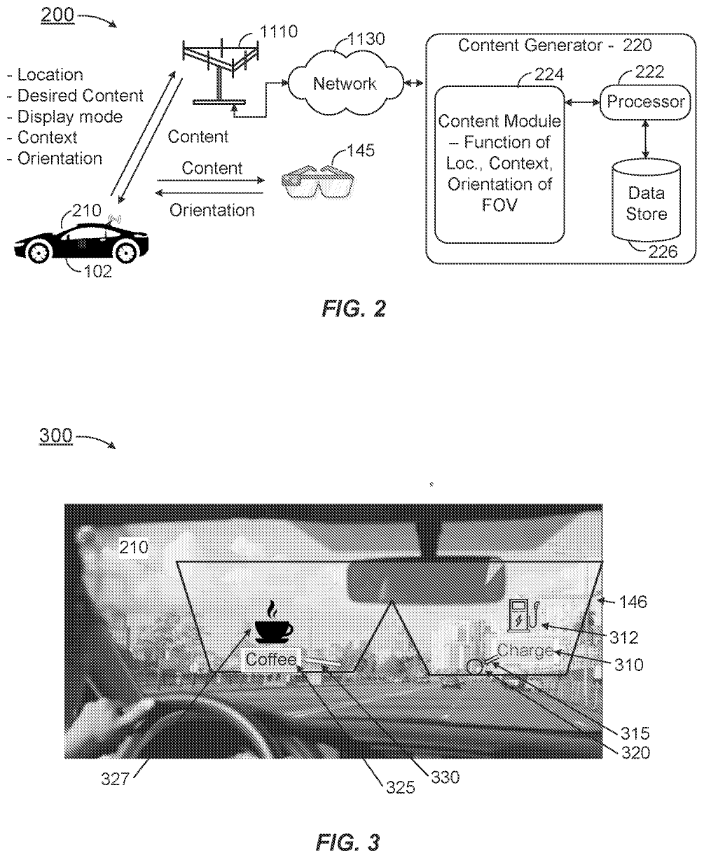

Augmented reality controller 110 may additionally receive input signals corresponding to positioning signals, which may comprise positioning signals transmitted from terrestrial-based cellular transceivers (e.g., cellular transceiver 1110 of FIG. 11) or may correspond to satellite positioning signals, such as provided by satellite 1114 (also shown in FIG. 11). In the embodiment of FIG. 1, such positioning signals may be utilized to assist location estimation module 130 to facilitate augmented reality content formatter 135 to receive signals representing appropriate content and format content for delivery to augmented reality glasses 145. Augmented reality controller 110 may comprise an input port for receiving content, for example, from a cloud-based content generator (such as described in relation to FIG. 2, herein).

Vehicle 102 may include an embedded communications system capable of communicating with the augmented reality glasses 145, or may utilize an individual's cellular mobile communications device to communicate with augmented reality glasses 145. Augmented reality glasses 145 may correspond to any of several candidate augmented reality devices, which may include augmented reality helmets, augmented reality displays (e.g., a head-up display), an augmented reality windshield, or the like. In one possible (and nonlimiting) embodiment, augmented reality glasses 145 correspond to the Microsoft® HoloLens system. Such augmented reality glasses include see-through holographic lenses, head tracking capabilities, inertial measurement capabilities utilizing accelerometers, gyroscopes, at least one magnetometer, built-in spatial sound, and other sensing capabilities. It should be noted that claimed subject matter is intended to embrace the above-identified device as well as any and all augmented and/or mixed reality glasses, virtually without limitation.

FIG. 2 is a diagram of a vehicle in wireless communications with augmented reality glasses to display relevant or associated content generated by a content generator, according to an embodiment 200. In the embodiment of FIG. 2, augmented reality glasses 145 may obtain positioning information from vehicle 102, either by way of a communications link directly with vehicle 102 or by way of a communications link with one or more cellular communications devices perhaps carried by a driver or a passenger of vehicle 102. Accordingly, augmented reality glasses 145 may, in cooperation with geolocation capabilities of vehicle 102, determine and/or report a location of glasses 145 as well as an orientation of the field of view of glasses 145. In particular embodiments, orientation of the field of view of augmented reality glasses 145 may be determined via output signals from at least one magnetometer or other type of sensor located within, or at least coupled to, augmented reality glasses 145. Accordingly, the augmented reality glasses 145 may allow a driver, passenger, or other individual wearing the glasses and located perhaps proximate to or within vehicle 102 to view real objects within the field of view of the augmented reality glasses 145 as well as view computer-generated objects, which may be displayed via a semi-transparent display of glasses 145 and overlaid on the real objects. Thus, a driver, passenger, or other individual proximate to vehicle 102 may be capable of viewing real objects, and view modifications or augmentations to the real objects via a layer of computer-generated objects or other features. Computer-generated features (e.g., computer-generated objects) may comprise symbols, such as arrows, triangles, solid, dotted and dashed lines, and any number of other shapes, which may comprise a variety of colors. Computer-generated objects may include alphanumeric characters which, in this setting, refer to characters of a standard alphabet (e.g., 26 characters of the English alphabet, 27 characters of the German alphabet, etc.) and numeric characters 0-9. Accordingly, for example, an alphanumeric response may comprise a single alphabetical character, such as “A,” multiple alphabetical characters, such as “ABCDE,” single or multiple numeric characters, such as “1,” or “123,” as well as combinations thereof, such as “ABC123 . . . ,” “A1B2C3 . . . .” Further, augmented reality glasses 145 may display computer-generated symbols, such as graphical icons indicating an availability of food and/or beverages at a particular location, traffic situations at a portion of a road, and any number of additional symbols, characters, and claimed subject matter is not limited in this respect.

Thus, the augmented reality glasses 145 may display computer-augmented real objects to a driver or passenger of vehicle 102. In particular embodiments, responsive to a driver of vehicle 102 wearing augmented reality glasses 145, a “driver” context may be selected or detected with or without receiving one or more input signals from, for example, the driver of a vehicle. Responsive to selection or detection of a “driver” context, the AR controller 110 may cause the glasses 145 to exclusively display traffic and/or safety-related symbols and/or characters and avoid presentation of potentially distracting content to the driver. In another embodiment, responsive to a passenger of vehicle 102 wearing augmented reality glasses 145, a “passenger” context may be invoked or selected. Responsive to selection or invocation of a “passenger” context, the AR controller 110 may cause glasses 145 to display traffic and/or safety-related symbols and/or characters and, in addition, may display other symbols and/or characters, such as those relating to availability of various goods and services, such as food and beverages, fuel and/or charging services, curios, etc., in an area at which the vehicle 102 is located.

Thus, it may be appreciated that augmented reality glasses 145 may provide content in the form of messages, symbols, indicators, etc., which may be appropriate under any number of contexts, such as a type-of-travel context. A type-of-travel context for an individual may indicate a mode of travel that the individual is engaged in (e.g., whether the individual is traveling in a vehicle versus walking, or a type of vehicle in which the individual is traveling), and/or indicate whether the individual has an operator role or a passenger role of the vehicle. In particular embodiments, a type-of-travel context may include a driving context (and indicate that the individual is travelling as a driver in a vehicle), passenger context (and indicate that the individual is travelling as a passenger in the vehicle), a walking context (and indicate that the individual is travelling by walking), or other context. Further, the type-of-travel context may additionally describe one or more other circumstances or conditions (also referred to as additional contexts or as sub-contexts) of the individual's travel, such as a weather or road condition of the travel. For example, the AR controller 110 or another computing device may detect, as part of a driving context, a second, weather-related context, such as a context related to “rainy weather” or “snowy weather.” In response to detecting such weather-related context, the AR controller 110 may cause the AR glasses 145 to display additional safety-related computer-generated content, such as messaging to indicate that a driver may be traveling too fast for rainy or snowy road conditions or conditions related to decreased visibility. In certain embodiments, if an AR controller 110 or other computing device detects a driving context, the AR controller 110 may cause the AR glasses 145 to display symbols related to driving directions, such as by displaying arrows (for example) to indicate an upcoming left turn, right turn, stop sign, etc.

As previously alluded to with respect to the embodiment of FIG. 2, augmented reality glasses 145 may cooperate with vehicle 102 perhaps by way of a cellular or other type of wireless link between glasses 145 and vehicle 102. Such communication may provide information indicating a present location and orientation of the field-of-view 146 (see FIG. 3) of glasses 145. As further stated above, the augmented reality controller 110 may receive content from a content generator. FIG. 2 illustrates an example content generator 220. Signals or other information representing a present location and a field of view of the AR glasses 145 may be transmitted to cellular transceiver 1110 and through network 1130 (such as described in reference to FIG. 11) to arrive at the content generator 220. Responsive to receipt of an estimate of the position of vehicle 102, and orientation of the field-of-view of glasses 145, the content generator 220 may operate to provide content that is relevant to or otherwise associated with real objects visible within the field-of-view of glasses 145. In the embodiment of FIG. 2, content generator 220 includes processor 222 (e.g., comprising one or more computer processors), which may communicate with a content module 224 to determine content suitable for transmitting to augmented reality glasses 145. Content suitable for transmitting to augmented reality glasses 145 may be determined responsive to processor 222 communicating with data store 226 (also referred to as a data storage device), which may comprise a memory device to store descriptors relating to real objects visible at locations within the field-of-view of glasses 145. The content generator 220 may then transmit content transmitted via network 1130, and through cellular transceiver 1110 for delivery to vehicle 102 (or for delivery to a device of an individual co-located with or proximate with vehicle 102.)

Content module 224 of content generator 220 may operate in the cloud to generate content appropriate for delivery to augmented reality glasses 145 based on one or more input signals. For example, in the embodiment of FIG. 2, content module 224 may provide content that is based, at least in part, on a present location of augmented reality glasses 145, a selected type-of-travel context (e.g., driving context, passenger context, walking context, etc.), and an orientation of the field-of-view (FOV) of glasses 145. In some implementations, the content generator 220 may select or otherwise generate content to be displayed to a driver and/or passenger based, at least in part, on location of the vehicle, user preferences for desired content (e.g., nearby shopping, charging stations, food and beverage establishments), a display mode (e.g., text and/or graphical icons), and claimed subject matter is not limited in this respect. Accordingly, as a possible example, the content generator 220 may receive a signal indicating that augmented reality glasses 145 worn by a driver is presently located just to the south of an entrance to Wrigley Field in Chicago, Illinois and the orientation of the field-of-view of augmented reality glasses 145 is directed northward toward an entrance to Wrigley Field. In response to receiving such a signal, the content module 224 may generate content to indicate one or more symbols associated with the entrance to Wrigley Field. These computer-generated symbols may be layered or otherwise overlaid on real objects present in a scene within the field-of-view of augmented reality glasses 145. In another possible example, responsive to a signal indicating that the augmented reality glasses 145 being worn by a passenger traveling within vehicle 102 is on an interstate highway in a desert portion of the United States in which a geographic density of charging stations may be relatively low, the content module 224 may generate content to indicate location and/or availability of vehicle charging services, such as a charging station located 5 km from the present location of vehicle 102 that is currently open and can accommodate fast charging for vehicle 102.

FIG. 3 depicts a view from a passenger located in a vehicle and viewing real objects in a scene in front of the vehicle while traveling on a road, according to an embodiment 300. As shown in FIG. 3, the passenger may view the scene through a windshield 210 and augmented reality glasses (having the field of view 146). The real objects include various buildings, foliage, road markings, and so forth that are within a line-of-sight of the passenger. The augmented reality glasses may display computer-generated content overlaid on the scene. The computer-generated content includes, e.g., alphanumeric message 325, concerning availability of a coffee shop along the vehicle's path as well as an approximate location, as indicated by arrow 330, of the coffee shop. In addition, alphanumeric message 310 is displayed to indicate presence of a charging station. The augmented reality glasses 145 may further display computer-generated content, such as an arrow 315 and circle 320, which indicate the approximate location of the charging station. As stated above, if the augmented reality glasses 145 or other augmented reality device is being worn by a passenger rather than by a driver, some embodiments may provide content that is not limited to safety-related content. Thus, if the augmented reality glasses 145 in FIG. 3 are currently being worn by a passenger of vehicle 102, the content module 224 of FIG. 2 may cause the augmented reality glasses 145 to display alphanumeric characters, symbols, and other content, that is not necessarily related to vehicle safety matters. Although not explicitly indicated in FIG. 3, as an individual wearing glasses 145 re-orients the field-of-view of glasses 145 (e.g., by turning his or her head), different parts of a scene or other imagery in front of the vehicle 102 may fall within the new field of view. For example, the change in field-of-view may cause a change in which real objects in the scene are viewable within the field-of-view of glasses 145. It should also be noted that although text descriptions, such as coffee message 325 and charge message 310, are displayed, a computing device (e.g., augmented reality controller 110, content generator 220, or augmented reality glasses 145) may receive a user selection (either by an operator of a vehicle or passenger) indicating whether graphical icons are to be displayed (e.g., coffee cup icon 327 or a charging station icon 312), whether text is to be displayed, and/or whether both text and graphical icons are to be displayed.

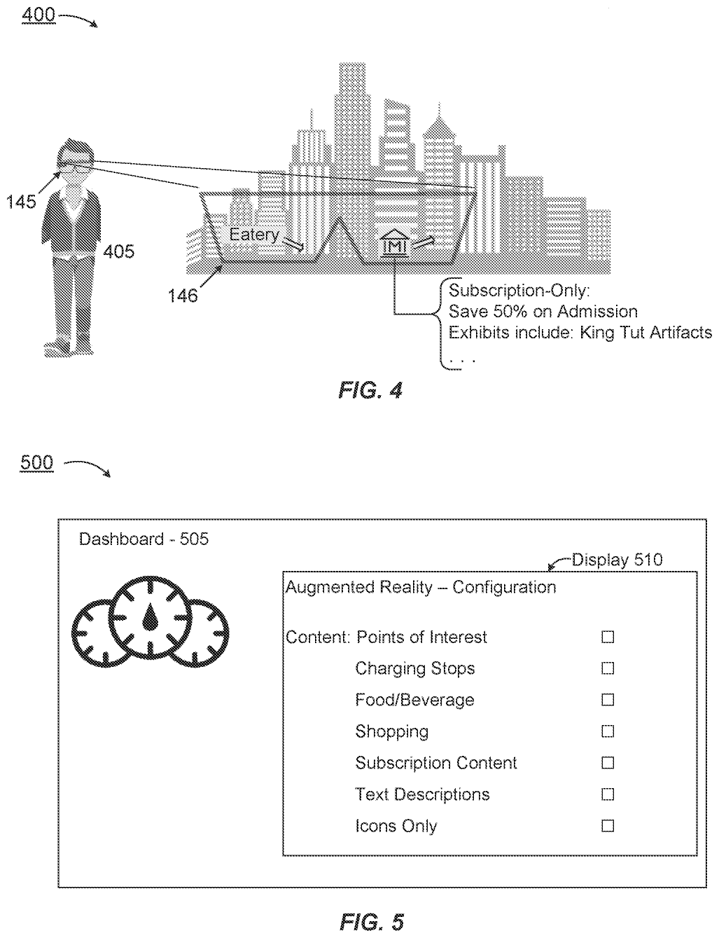

FIG. 4 depicts an individual walking in a city environment while wearing augmented reality glasses, according to an embodiment 400. In such an embodiment, which may result from individual 405 selecting a “walking” mode, the content generator 220 of FIG. 2 may cause augmented reality glasses 145 to display presence of a restaurant (e.g., “Eatery”) or a museum (e.g., as indicated by an appropriate icon) in field-of-view 146 of glasses 145. Although not explicitly indicated in FIG. 4, as individual 405 re-orients the field-of-view of glasses 145, different imagery and/or real objects may be present within the field-of-view of glasses 145. In particular embodiments, a user in a walking mode, for example, may select to display subscription-only content. In such a context, as shown in FIG. 4, a user in a walking mode viewing a point-of-interest, such as a museum, may be provided with an offer to save on an admissions fee, or may be provided with a description of the museum's exhibits, hours of operation as well as numerous other parameters and/or content, and claimed subject matter is not limited in this respect.

FIG. 5 depicts a dashboard 505, or more generally a user interface, of a vehicle. The user interface may display a menu that presents settings to configure augmented reality glasses, according to an embodiment 500. Dashboard 505 may include gauges, such as a speedometer, tachometer, fuel gauge (or charge indication), as well as a display 510. In an embodiment, display 510 may correspond to a configuration menu for augmented reality displays, such as an augmented reality display viewable via windshield 210 of vehicle 102 (having a heads-up display) and/or via augmented reality glasses 145. In the embodiment of FIG. 5, augmented reality content may be selected via a touchscreen display, for example, in which a passenger or driver of vehicle 102 selects particular content to be displayed. Such content may include points of interest (e.g., museums, parks, scenic viewpoints, items of historical interest, etc.), charging stops (e.g., charging stations that provides suitable charging waveforms for vehicle 102), food and beverage establishments (e.g., restaurants, coffee shops, drive-through beverage establishments, etc.), shopping (e.g., department stores, hardware stores, etc.), and numerous other types of displayable augmented reality content. Display 510 may facilitate selection of numerous additional configuration parameters of augmented reality content, and claimed subject matter is not limited in this respect. In addition, display 510 may also facilitate an operator or passenger of vehicle 102 to select whether augmented reality content is to be displayed via text-based descriptors (such as alphanumeric characters) and/or via graphical icons, such as icons to represent coffee shops, charging stations, etc., as described in reference to FIG. 3. Accordingly, display 510 may facilitate selection of types of augmented reality content to be displayed as well as whether such content is to be displayed utilizing alphanumeric text, graphical icons, or a combination thereof.

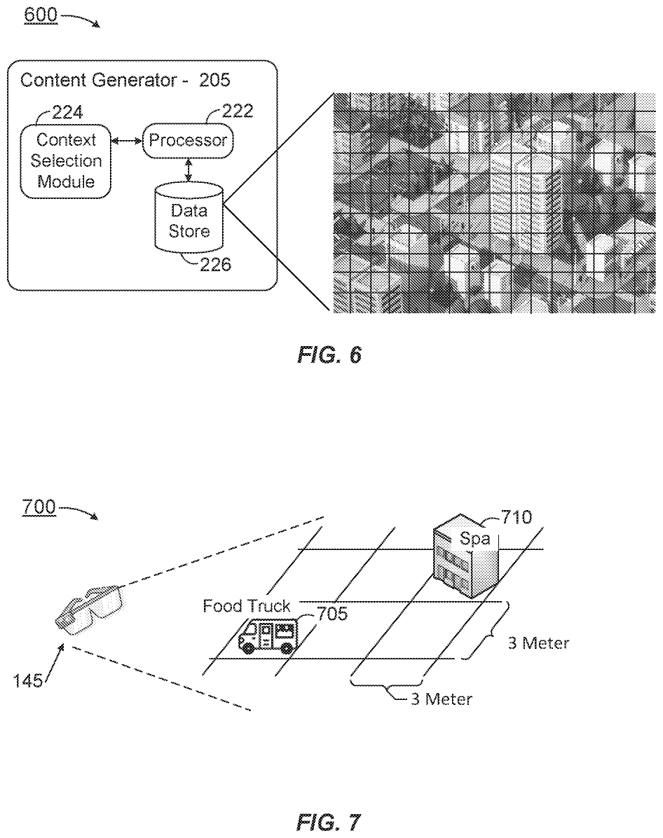

FIG. 6 is a diagram showing the content generator of FIG. 2 along with a portion of a city that has been divided into uniformly-sized areas, according to an embodiment 600. As depicted in FIG. 6, larger areas, such as areas comprising one or more city blocks may be divided into uniformly-sized known areas of a grid. Within the standard-sized known areas of the grid, parameters related to keypoints of real objects present in the uniformly-sized areas may be loaded into a memory, such as data store 226. Thus, it may be appreciated that in view of FIG. 6, a computing device (e.g., augmented reality controller 110 and/or content generator 205) may track a location of an individual. As the individual moves from a first known uniformly-sized area of the grid to a second known uniformly-sized area of the grid, the computing device may obtain or otherwise generate content that is associated with (e.g., relevant to) the second known uniformly-sized area of the grid, and may cause the augmented reality glasses 145 to display the generated content. In addition, content may be determined to be relevant according to a type-of-travel context (e.g., road travel context, walking travel context, etc.), wherein the type-of-travel context may be determined based on a selection by an individual wearing augmented reality glasses 145.

In the embodiment of FIG. 6, a computing device (e.g., augmented reality controller 110 or content generator 220/205) may obtain a selection from an individual, such as individual 405 manipulating a graphical user interface of a communications device (e.g., within vehicle 102), that indicates a location of the individual. The selection may serve to assist the content generator 205/220 in ascertaining the precise location of individual 405 (of FIG. 4). For example, responsive to content generator 205 being unable to precisely determine, estimate, and/or resolve a location of an individual 405, content generator 205 may transmit descriptors pertaining to two or more uniformly-sized areas that may be nearby individual 405. Individual 405 may then, responsive to performing a comparison between or among received descriptors of real objects from memory elements, such as data store 226 and real objects proximate or in view of individual 405, be capable of selecting the particular uniformly-sized area in which the individual is presently located. Thus, by presenting certain imagery to individual 405, the individual may assist in determining, estimating, and/or resolving his or her precise location with respect to a particular uniformly-sized area of a larger grid.

FIG. 7 is a diagram showing real objects viewable through augmented reality glasses 145, wherein certain real objects are considered nearby relative to the augmented reality glasses or an individual wearing the augmented reality glasses, and other objects are considered distant relative to the individual or the augmented reality glasses, according to an embodiment 700. The objects may be considered nearby if they satisfy a predefined (or dynamically defined) proximity condition (e.g., a condition in which the objects are within a predefined radius of the augmented reality glasses or of the individual), and may be considered distant if they satisfy a predefined remote condition (e.g., a condition in which the objects are outside the predefined radius of the augmented reality glasses or of the individual). As shown in FIG. 7 an area or region may be divided into uniformly-sized areas, such as areas of a grid measuring approximately 3.0 meter by approximately 3.0 meter. It should be noted, however, that alternative embodiments may include division of a larger area into non-uniformly-sized areas. For example, in particular embodiments, an area of a densely populated metropolitan area may be divided into smaller-sized areas, such as areas measuring approximately 2.0 meter by approximately 2.0 meter, areas measuring approximately 3.0 meter by approximately 3.0 meter, or areas measuring approximately 4.0 meter by approximately 4.0 meter, and claimed subject matter is not limited to particular dimensions of uniformly-sized smaller areas of a larger area. In addition, certain portions of a larger area may be divided into smaller portions having a first area while other portions of a larger area may be divided into smaller portions having a second area. For example, for an area that transitions from a densely populated urban area to a less dense suburban area, a first group of areas may be divided into smaller-sized areas, such as areas measuring approximately 3.0 meter by approximately 3.0 meter. After transitioning from the urban area to the less dense suburban area, a second group of areas may be divided into areas measuring, for example, approximately 4.0 meter by approximately 4.0 meter. Further, after transitioning from a suburban area to a rural area, a third group of areas may be divided into differently-sized areas, such as areas measuring, for example, approximately 10.0 meter by approximately 10.0 meter. It should be noted that claimed subject matter is intended to embrace a wide variety of divisions of larger areas into smaller areas, so as to provide a level of detail that is appropriate to a number of real objects that may be expected to be present in a particular known area of the grid.

In the embodiment of FIG. 7, in response to a passenger in an vehicle selecting a road-travel context, for example, a computing device (e.g., augmented reality controller 110 or content generator 205/220) may cause augmented reality glasses 145 to display content relevant to or associated with nearby real objects in addition to content relevant to or associated with real objects relatively distant from the augmented reality glasses 145. For example, the computing device may receive a user selection that a context of the user is as a passenger in a vehicle in a road travel context or that the context of the user is a walking travel context. In response to such a user selection, the computing device may display an alphanumeric message to identify nearby object 705. More particularly, the alphanumeric message may be a message reciting “Food Truck” and may be displayed within the field-of-view of augmented reality glasses 145. In addition, in response to an individual wearing the glasses lifting his or her head, augmented reality glasses 145 may determine that the user is attempting to view a real object farther from nearby object 705. Such head movement, which may be accompanied by detection of head movement slightly to the left or right, may indicate that the individual wearing glasses 145 is attempting to view a real object that is somewhat distant from the individual. Accordingly, augmented reality glasses 145 may display content related to spa 710, which may be positioned at a location that is more distant from glasses 145 than nearby object 705.

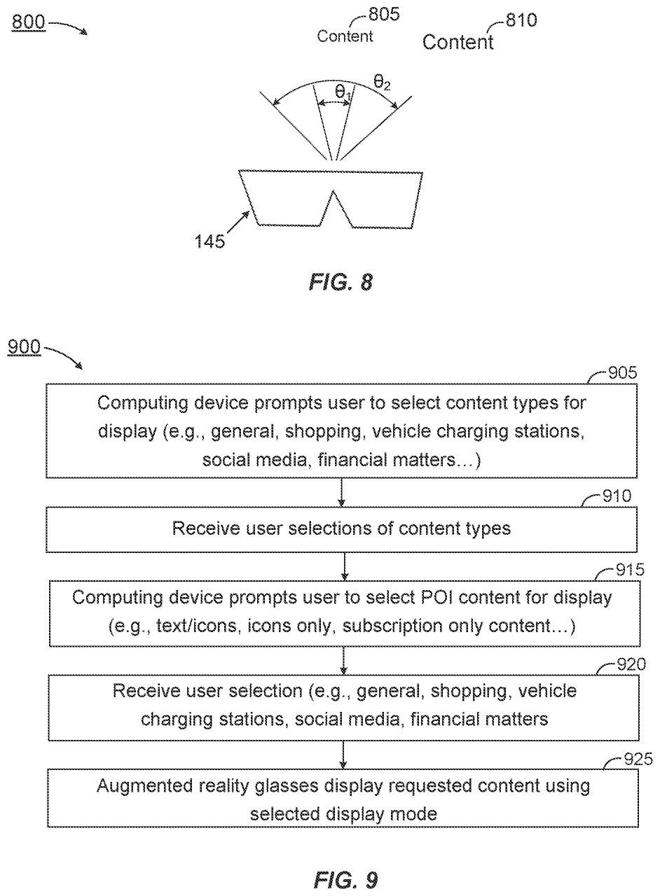

In an embodiment, the augmented reality glasses may display content in a manner based on whether the content falls within a center portion of a field of view of the augmented reality glasses, or whether the content falls in a peripheral portion of the field of view. FIG. 8 is a diagram showing certain angles that define a central portion and a peripheral portion of a field of view of augmented reality glasses or other augmented reality device, according to an embodiment 800. As indicated in FIG. 8, particular areas and/or real objects viewable through augmented reality glasses 145 may be considered to be in a more central, strictly direct line-of-sight of the field-of-view, such as areas that fall within a solid angle given by a predefined angle θ₁ in FIG. 8, wherein the angle θ₁ may be relative to a central axis of the field of view. The central portion of the field of view may be a cone defined by the angle θ₁. On the other hand, other areas and/or real objects viewable through augmented reality glasses 145 may be considered to be more on a periphery of the field-of-view, such as areas outside of the solid angle given by θ₁ up to the boundaries of the angle given by θ₂. Thus, the peripheral portion of the field of view may be a region that is outside the central portion of the field of view, but is still within a cone defined by the angle θ₂. In particular embodiments, the computing device (e.g., augmented reality controller, content generator, and/or augmented reality glasses) may control how a content is displayed based on whether the content will fall within the central portion of the field of view of the augmented reality glasses, or whether the content will fall within the peripheral portion. For example, a size of content that is displayed on the augmented reality glasses may be based on whether the content falls within the central portion (given by θ₁) or whether the content falls in the peripheral portion (outside the given angle θ₁). For instance, the delivered content for viewing within the solid angle given by θ₁ may be displayed utilizing, for example, smaller-sized alphanumeric characters than content for viewing outside of the solid angle given by θ₁. For example, as shown in FIG. 8, the text depicting “Content” (805) located within the angle given by θ₁ may be rendered in text that is somewhat smaller than the text depicting “Content” (810) located outside of the solid angle given by θ₁. In particular embodiments, rendering content outside of a more central portion of a field-of-view may prompt an individual to take greater notice of potentially important visual cues that may otherwise have gone unnoticed by an individual wearing augmented reality glasses 145.

FIG. 9 is a first flowchart for a method for context-sensitive overlay of content via an augmented reality device, according to an embodiment 900. It should be noted that the process represented by the flowchart of FIG. 9, as well as other flowcharts described herein, may include actions in addition to those depicted in the figure and/or may include actions arranged in an order different than that shown in FIG. 9. The method of FIG. 9 may begin at 905, in which a computing device, such as a computing device (e.g., augmented reality controller) onboard a vehicle, such as vehicle 102 of FIG. 1, may prompt an user, which may correspond to a driver of vehicle 102 or passenger of vehicle 102, to select a type(s) of content (also referred to as content type(s)) for display. Content types for display may include, e.g., general content, shopping-related content, content related to upcoming vehicle charging stations, upcoming vehicle fuel stations, content types related to social media driven events, banks, and/or other financial-related establishments, etc. In particular embodiments, an operator of vehicle 102 may select to view safety matters and/or upcoming vehicle charging stations, so as to avoid being distracted by displayed points of interest that may disturb focus and/or concentration. Also in particular embodiments, a passenger of vehicle 102 may select to view a wider variety of points of interest (POI).

At 910, a computing device onboard a vehicle, for example, may receive user selections of content types. The method may continue at 915, which may include a computing device onboard a vehicle prompting an operator, for example, to select POI content for display. Such content may include text and/or graphical icons for display as augmented reality content. In certain embodiments, displayed content may additionally include subscription only content, such as details of particular points of interest, food/beverage establishments, charging station offerings, etc. The method may continue at 920, which may bring about vehicle 102 communicating with content generator 220, so as to filter out certain, perhaps distracting content and/or content that is of little interest to an operator or passenger of vehicle 102. At 925, augmented reality content may be displayed to a user (e.g., an operator or a passenger of vehicle 102).

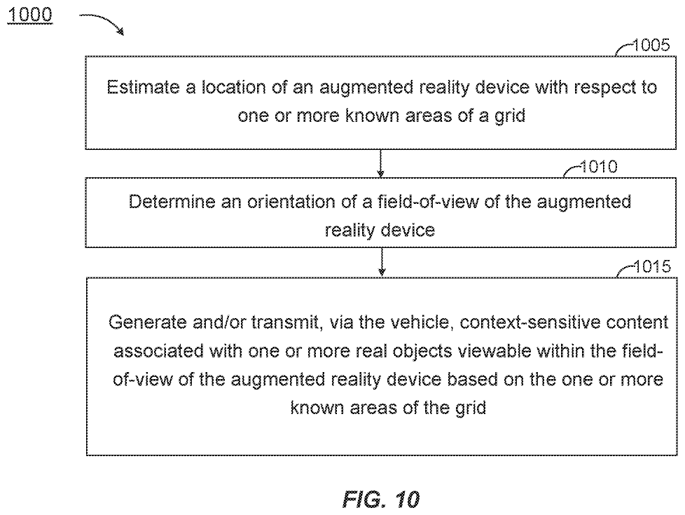

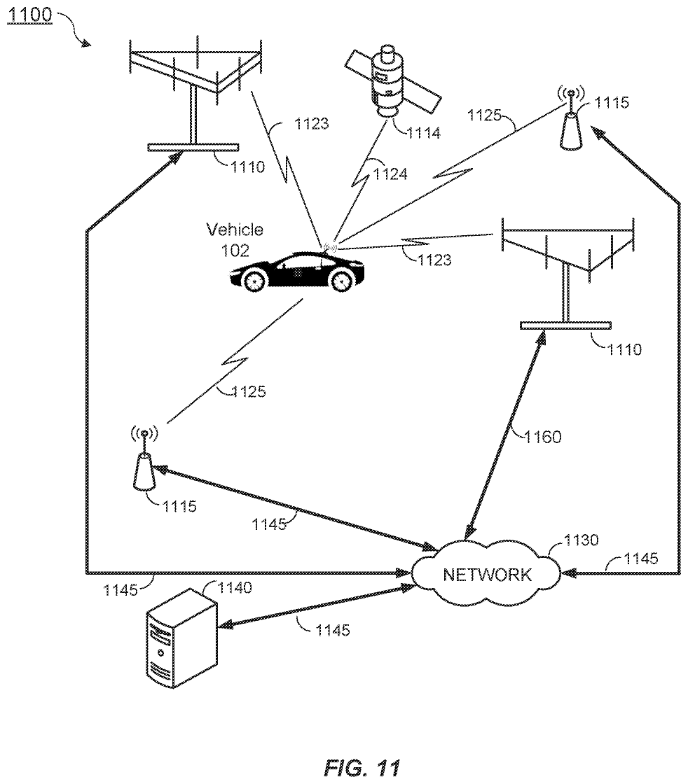

FIG. 10 is a second flowchart for a method for context-sensitive overlay of content via an augmented reality device, according to an embodiment 1000. The method of FIG. 10 may begin at 1005, which may include resolving or estimating a location of an augmented reality device with respect to one or more known areas of the grid, such as grid area 105 of FIG. 1. The method may continue at 1010, which may include determining the orientation of the field-of-view of the augmented reality device, such as augmented reality glasses 145. The method may continue at 1015, which may include generating and/or transmitting via the vehicle, context-sensitive content associated with one or more real objects viewable within the field-of-view of the augmented reality device based on the one or more known areas of the grid.

FIG. 11 is a diagram of a communications infrastructure that includes both wireless and wireline communications devices and components, according to various embodiments. In FIG. 11, corresponding to embodiment 1100, vehicle 102, in addition to performing automotive transport functions, provides a capability to communicate with a wireless communications infrastructure either as an embedded capability, or via a connection, such as a Bluetooth connection, with any of several types of mobile cellular communications devices. Such capabilities may include telephone communications, texting, web browsing, providing wireless hotspot capability, and so forth. In the embodiment of FIG. 11, vehicle 102 may, either as an embedded capability or via a wired or wireless connection with an individual's mobile cellular communications device, transmit radio signals to, and receive radio signals from, a wireless communications network. In an example, vehicle 102 may facilitate communications with a cellular communications network by transmitting wireless signals to, and/or receiving wireless signals from, a cellular transceiver 1110, which may comprise a wireless base transceiver subsystem, a Node B or an evolved NodeB (eNodeB), over wireless communication link 1123. Similarly, vehicle 102 may transmit wireless signals to, and/or receive wireless signals from, local transceiver 1115 over wireless communication link 1125. A local transceiver 1115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed herein). Of course, it should be understood that these are merely examples of networks that may communicate with a mobile device over a wireless link, and claimed subject matter is not limited in this respect. In particular embodiments, cellular transceiver 1110, local transceiver 1115, satellite 1114, represent touchpoints, which permit vehicle 102 to interact with network 1130.

In a particular implementation, cellular transceiver 1110 and local transceiver 1115 may communicate with server 1140, such as by way of network 1130 via communication links 1145. Here, network 1130 may comprise any combination of wired or wireless links and may include cellular transceiver 1110 and/or local transceiver 1115 and/or server 1140. In a particular implementation, network 1130 may comprise Internet Protocol (IP) or other infrastructure capable of facilitating communication between vehicle 102 at a call source and server 1140 through local transceiver 1115 or cellular transceiver 1110. In an embodiment, network 1130 may also facilitate communication between vehicle 102 and server 1140, for example, through communications link 1160. In another implementation, network 1130 may comprise a cellular communication network infrastructure such as, for example, a base station controller or packet based or circuit based switching center (not shown) to facilitate mobile cellular communication with vehicle 102. In a particular implementation, network 1130 may comprise local area network (LAN) elements such as WiFi APs, routers and bridges and may, in such an instance, comprise links to gateway elements that provide access to wide area networks such as the Internet. In other implementations, network 1130 may comprise a LAN and may or may not involve access to a wide area network but may not provide any such access (if supported) to vehicle 102. In some implementations, network 1130 may comprise multiple networks (e.g., one or more wireless networks and/or the Internet). In one implementation, network 1130 may include one or more serving gateways or Packet Data Network gateways. In addition, one or more of server 1140 may comprise an E-SM LC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 1130.

In particular embodiments, communications between vehicle 102 and cellular transceiver 1110, satellite 1114, local transceiver 1115, and so forth may occur utilizing signals communicated across wireless or wireline communications channels. Accordingly, the term “signal” may refer to communications utilizing propagation of electromagnetic waves or electronic signals via a wired or wireless communications channel. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in one or more signals using one or more of the above-identified modulation techniques.

In particular implementations, and as discussed below, vehicle 102 (e.g., as an embedded capability or via a wired or wireless connection with an individual's mobile cellular communications device) may comprise circuitry and processing resources capable of obtaining location related measurements (e.g., for signals received from GPS or other satellite positioning system (SPS) satellites 1114), cellular transceiver 1110 or local transceiver 1115 and possibly computing a position fix or estimated location of vehicle 102 based on these location related measurements. In some implementations, location related measurements obtained by vehicle 102 may be transferred to a location server such as an enhanced serving mobile location center (E-SMLC) or SUPL location platform (SLP) (e.g. which may comprise a server, such as server 1140) after which the location server may estimate or determine an estimated location for vehicle 102 based on the measurements. In the embodiment of FIG. 11, location-related measurements obtained at vehicle 102 may include measurements of signals 1124 received from satellites belonging to an SPS or Global Navigation Satellite System (GNSS) such as GPS, GLONASS, Galileo or Beidou and/or may include measurements of signals (such as 1123 and/or 1125) received from terrestrial transmitters fixed at known locations (e.g., such as cellular transceiver 1110).

Vehicle 102, either as an embedded capability or via a wired or wireless connection with an individual's mobile cellular communications device, may obtain a location estimate for vehicle 102 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at vehicle 102 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at vehicle 102. Here, server 1140 may be capable of providing positioning assistance data to vehicle 102 (or to an individual's mobile cellular communications device within vehicle 102) including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CI D. For example, server 1140 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, vehicle 102 may obtain measurements of signal strengths for signals received from cellular transceiver 1110 and/or local transceiver 1115 and/or may obtain a round trip signal propagation time (RTT) between vehicle 102 and a cellular transceiver 1110 or local transceiver 1115. Vehicle 102 may use these measurements together with assistance data (e.g. terrestrial almanac data or GNSS satellite data such as GNSS Almanac and/or GNSS Ephemeris information) received from server 1140 to determine a location estimate for vehicle 102 or may transfer the measurements to server 1140 to perform the same determination. A call from vehicle 102 may be routed, based on the location of vehicle 102 via wireless communication link 1123 and communications link 1160.

In response to receipt of signals from GPS or from other satellite positioning system (SPS) satellites, or in response to other positioning approaches, such as those described hereinabove, vehicle 102 for example, may compute or estimate its location. In particular embodiments, an outcome of a location estimation process may be expressed utilizing three variables, such as latitude, longitude, and elevation. However, in particular embodiments an estimated or computed position may take any other form, such as to express coordinates in a Universal Transverse Mercator coordinates, or may be expressed utilizing coordinates that accord with World Geodetic System 84 (WGS 84), or may be expressed utilizing any other coordinate system, and claimed subject matter is not limited in this respect.

Responsive to vehicle 102, either as an embedded capability or by way of an interface to an individual's mobile cellular communications device, may comprise an embedded sensor suite which may, for example, include inertial sensors and environment sensors. Inertial sensors may comprise, for example accelerometers (e.g., collectively responding to acceleration of vehicle 102 in and x-direction, a y-direction, and a z-direction). Vehicle 102 may further include one or more gyroscopes or one or more magnetometers (e.g., to support one or more compass applications). Environment sensors of vehicle 102 may comprise, for example, temperature sensors, barometric pressure sensors, ambient light sensors, camera imagers, microphones, just to name few examples. Sensors of vehicle 102 may generate analog or digital signals that may be stored in utilizing one or more memory locations in support of one or more applications such as, for example, applications collecting or obtaining biometric attributes of an individual driver, for example.

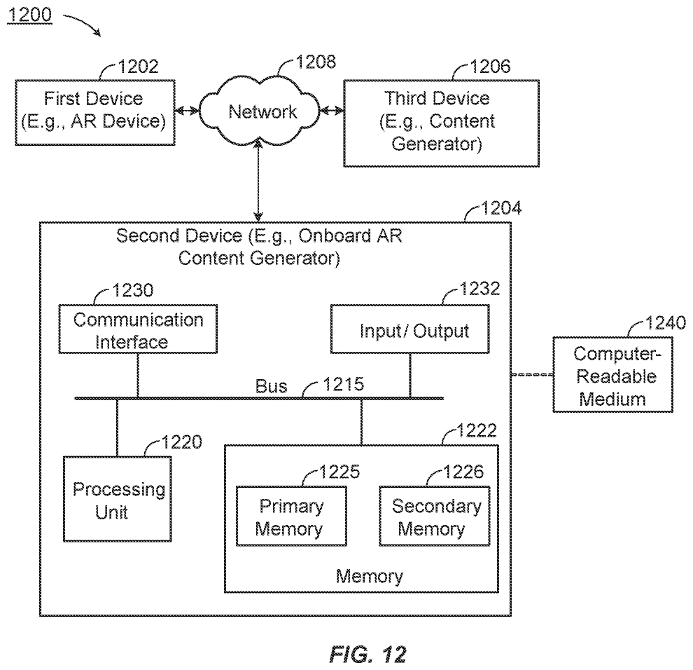

FIG. 12 is a diagram showing a computing environment, according to an embodiment 1200. In the embodiment of FIG. 12, first device 1202, which may comprise an augmented reality device (e.g., augmented reality glasses), may receive signals, for example, from third device 1206, which may correspond to a content generator, such as content generator 205 of FIG. 6. In the embodiment of FIG. 12, first device 1202 may be capable of rendering signals from third device 1206 (e.g., content generator) so that a driver and/or a passenger of vehicle 102 may receive text and/or imagery relevant to or associated with real objects viewable through a windshield (e.g., windshield 210 of FIG. 3) and/or augmented reality glasses 145 (for example). The second device 1204, may potentially operate as onboard content formatter 135 (of FIG. 1), which may generate context-sensitive content viewable by the driver and/or a passenger of the vehicle. In FIG. 12, computing device 1202 (‘first device’) may communicate with second device 1204, which may, for example, also comprise features of at least one computer processor coupled to at least one memory device and/or a server computing device. Processor (e.g., comprising one or more computer processors) 1220 and memory 1222, which may comprise primary memory 1225 and secondary memory 1226, may communicate by way of a communication interface 1230, for example. The term “computing device,” or “computing resource” in the present patent application, refers to a system and/or a device, such as a computing apparatus that includes a capability to process (e.g., perform computations) and/or store digital content, such as electronic files, electronic documents, measurements, text, images, video, audio, etc. in the form of signals and/or states. Thus, a computing device, in the setting or environment of the present patent application, may comprise hardware, software, firmware, or any combination thereof (other than software per se). Second device 1204, as depicted in FIG. 12, is merely one example, and claimed subject matter is not limited in scope to this particular example.

In FIG. 12, computing device 1202 may provide one or more sources of executable computer instructions in the form of physical states and/or signals (e.g., stored in memory states), for example. Computing device 1202 may communicate with computing device 1204 by way of a network connection, such as via network 1208, for example. As previously mentioned, a connection, while physical, may be virtual while not necessarily being tangible. Although second device 1204 of FIG. 12 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1222 may comprise any non-transitory storage mechanism. Memory 1222 may comprise, for example, primary memory 1225 and secondary memory 1226, additional memory circuits, mechanisms, or combinations thereof may be used. Memory 1222 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1222 may comprise one or more articles utilized to store a program of executable computer instructions. For example, processor 1220 (which may comprise one or more computer processors) may fetch executable instructions from memory and proceed to execute the fetched instructions. Memory 1222 may also comprise a memory controller for accessing device readable-medium 1240 that may carry and/or make accessible digital content, which may include code, and/or instructions, for example, executable by processor 1220 and/or some other device, such as a controller, as one example, capable of executing computer instructions, for example. Under direction of processor 1220 (e.g., one or more computer processors), a non-transitory memory, such as memory cells storing physical states (e.g., memory states), comprising, for example, a program of executable computer instructions, may be executed by processor 1220 and able to generate signals to be communicated via a network, for example, as previously described. Generated signals may also be stored in memory, also previously suggested.

Memory 1222 may store electronic files and/or electronic documents, such as relating to one or more users, and may also comprise a machine-readable medium that may carry and/or make accessible content, including code and/or instructions, for example, executable by processor 1220 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the setting or environment of the present patent application, and generally, is considered to be a self-consistent sequence of operations and/or similar signal processing leading to a desired result. In the setting or environment of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 1220 may comprise one or more circuits, such as digital circuits, to perform at least a portion of a computing procedure and/or process. By way of example, but not limitation, processor 1220 may comprise one or more processors, such as controllers, micro-processors, micro-controllers, application specific integrated circuits, digital signal processors, programmable logic devices, field programmable gate arrays, the like, or any combination thereof. In various implementations and/or embodiments, processor 1220 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 12 also illustrates device 1204 as including a component 1232 operable with input/output devices, and communication bus 1215, for example, so that signals and/or states may be appropriately communicated between devices, such as device 1204 and an input device and/or device 1204 and an output device. A user may make use of an input device, such as a computer mouse, stylus, track ball, keyboard, and/or any other similar device capable of receiving user actions and/or motions as input signals. Likewise, for a device having speech-to-text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

Unless otherwise indicated, in the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An augmented reality controller for conveying content to an augmented reality device in communication with a vehicle, the augmented reality controller comprising:
at least one memory device storing computer program code;
one or more processors communicatively coupled to the at least one memory device and configured, when executing the computer program code, to:
estimate a location of the augmented reality device with respect to one or more known areas of a grid;
determine an orientation of a field-of-view of the augmented reality device; and
transmit, via the vehicle, context-sensitive content to the augmented reality device for display thereon, the context-sensitive content being associated with one or more real objects viewable within the field-of-view of the augmented reality device, and being generated based, at least in part, on the one or more known areas of the grid.

2. The augmented reality controller of claim 1, the one or more processors communicatively coupled to the at least one memory device being additionally configured to:
access a cloud-based data storage device to determine the context-sensitive content based, at least in part, on one or more content preferences of an individual who is currently in the vehicle or who satisfies a predefined proximity condition relative to the vehicle.

3. The augmented reality controller of claim 2, the one or more processors communicatively coupled to the at least one memory device being additionally configured to:
receive user selection of a type-of-travel context from among a plurality of selectable type-of-travel contexts, wherein the type-of-travel context indicates a mode of travel that the individual is engaged in, or indicates whether the individual has a vehicle operator role or a vehicle passenger role,
wherein the data storage device is accessed based, at least in part, on the user selection of the type-of-travel context, such that the context-sensitive content is based on the type-of-travel context.

4. The augmented reality controller of claim 3, wherein, in response to the user selection of the type-of-travel context, the one or more processors communicatively coupled to the at least one memory device are additionally configured to:
transmit to the augmented reality device, via the vehicle, the context-sensitive content based, at least in part, on the one or more real objects being located along a driving path of travel of the vehicle.

5. The augmented reality controller of claim 3, wherein, responsive to selecting the type-of-travel context, the one or more processors communicatively coupled to the at least one memory device is additionally configured to:
transmit to the augmented reality device, via the vehicle, the context-sensitive content based, at least in part, on the one or more real objects being located along a walking path of travel.

6. The augmented reality controller of claim 1, wherein the one or more processors communicatively coupled to the at least one memory device are configured to perform the estimate of the location of the augmented reality device by:
receiving a selection of at least one area of the one or more known areas of the grid from among a plurality of uniformly-sized areas within a predefined proximity to the estimated location of the vehicle.

7. The augmented reality controller of claim 6, wherein the plurality of uniformly-sized areas correspond to areas of approximately 3.0 m by approximately 3.0 m.

8. The augmented reality controller of claim 1, the one or more processors communicatively coupled to the at least one memory device being additionally configured to:
determine whether the one or more real objects viewable within the field-of-view of the augmented reality device satisfies a predefined proximity condition in which the one or more real objects are considered relatively nearby to an individual co-located with the augmented reality device, or whether the one or more real objects satisfies a predefined remote condition in which the one more real objects are considered relatively distant from the individual, wherein the context-sensitive content is generated based on whether the one more real objects satisfies the predefined proximity condition or whether the one or more real objects satisfies the predefined remote condition.

9. The augmented reality controller of claim 1, the one or more processors communicatively coupled to the at least one memory device being additionally configured to:
determine whether the one or more real objects viewable within the field-of-view of the augmented reality device is located within a peripheral portion of the field-of-view of the augmented reality device, or is within a central portion of the field-of-view of the augmented reality device, wherein the central portion of the field-of-view is a portion within a first predefined angle relative to a central axis of the field-of-view, and wherein the peripheral portion is another portion that is outside the central portion of the field-of-view.

10. The augmented reality controller of claim 1, the one or more processors communicatively coupled to the at least one memory device being additionally configured to:
receive, from a graphical user interface of the vehicle, a user selection to display the context-sensitive content utilizing alphanumeric characters, graphical icons, or a combination thereof.

11. A method to provide content to an augmented reality device in communication with a vehicle, the method being performed by one or more processors and comprising:
estimating a location of the augmented reality device with respect to one or more known areas of a grid;
determining an orientation of a field-of-view of the augmented reality device; and
generating and/or transmitting, via the vehicle, context-sensitive content associated with one or more real objects viewable within the field-of-view of the augmented reality device based on the one or more known areas of the grid.

12. The method of claim 11, further comprising:
accessing a data storage device to determine the context-sensitive content based, at least in part, on one or more content preferences of an individual who is currently in the vehicle or who satisfies a predefined proximity condition relative to the vehicle.

13. The method of claim 12, further comprising:
receiving user selection of a type-of-travel context of the individual from among a plurality of types-of-travel contexts, wherein the type-of-travel context indicates a mode of travel that the individual is engaged in, or indicates whether the individual has a vehicle operator role or a vehicle passenger role,
wherein the content is generated based on the type-of-travel context.

14. The method of claim 13, further comprising:
transmitting, responsive to selecting the type-of-travel context, the context-sensitive content associated with the one or more real objects based, at least in part, on the one or more real objects being located along a driving path of travel of the vehicle.

15. The method of claim 11, further comprising:
receiving a selection of the one or more known areas of the grid from among a plurality of uniformly-sized areas within a predefined proximity to the location of the augmented reality device and/or the vehicle.

16. The method of claim 15, wherein the plurality of uniformly-sized areas correspond to areas approximately 3.0 m by approximately 3.0 m.

17. A non-transitory computer-readable medium comprising program instructions for causing one or more processors of an augmented reality controller to perform at least the following:
estimating a location of an augmented reality device with respect to one or more known areas of a grid;
determining an orientation of a field-of-view of the augmented reality device; and
transmitting context-sensitive content to the augmented reality device via a vehicle, the context-sensitive content being associated with one or more real objects viewable within the field-of-view of the augmented reality device, and being generated based, at least in part, on the one or more known areas of the grid.

18. The non-transitory computer-readable medium of claim 17, wherein the program instructions are additionally cause the one or more processors to:
access a cloud-based data storage device to determine the context-sensitive content based, at least in part, on one or more content preferences of an individual who is currently in the vehicle or who satisfies a predefined proximity condition relative to the vehicle.

19. The non-transitory computer-readable medium of claim 18, wherein the program instructions additionally cause the one or more processors to:
receive user selection of a type-of-travel context from among a plurality of selectable type-of-travel contexts, wherein the type-of-travel context indicates a mode of travel that the individual is engaged in, or indicates whether the individual has a vehicle operator role or a vehicle passenger role, wherein the data storage device is accessed based, at least in part, on the user selection of the type-of-travel context, such that the context-sensitive content is based on the type-of-travel context.

20. The non-transitory computer-readable medium of claim 17, wherein the program instructions additionally cause the one or more processors to:
determine whether the one or more real objects viewable within the field-of-view satisfies a predefined proximity condition in which the one or more real objects are considered relatively nearby to an individual co-located with the augmented reality device, or whether the one or more real objects satisfies a predefined remote condition in which the one more real objects are considered relatively distant from the individual, wherein the context-sensitive content is generated based on whether the one more real objects satisfies the predefined proximity condition or whether the one or more real objects satisfies the predefined remote condition.
